(19) United States
(12) Patent Application Publication
(10) Pub. No.: US 2021/0221586 A1
(43) Pub. Date: Jul. 22, 2021

(54) LONG-TERM TEMPERATURE MAINTENANCE BAG

(71) Applicant: L&G Barbeque Grills LLC, Woburn, MA (US)

(72) Inventors: Leonidas Carayannopoulos, Woburn, MA (US); George Tsitsopoulos, Woburn, MA (US); Zack Tucci, Woburn, MA (US); Stamatis Carayannopoulos, Woburn, MA (US)

(21) Appl. No.: 16/748,230

(22) Filed: Jan. 21, 2020

(51) Int. Cl. B65D 65/14; B65D 33/10; B65D 33/16; B65D 75/06; B65D 81/38; B29C 65/48; B29C 65/78

(52) U.S. Cl. CPC B65D 65/14; B65D 33/105; B65D 33/1691; B29C 65/78; B65D 81/389; B29C 65/48; B65D 75/06

(57) ABSTRACT

Described embodiments provide systems and methods for controlling the temperature of an item with a sheet. The sheet includes a front side and an obverse side, a first adhesive disposed along a first edge of the sheet on the front side of the sheet, such that when the sheet is folded over the item, the first adhesive engages with the front side of the sheet to create a container pocket having a container volume; and a second adhesive disposed on the front side of the sheet such that when the sheet is folded over the item, the second adhesive engages with the sheet to create a temperature control pocket with a volume less than the container volume. The sheet also includes a third adhesive for engaging with an ice pack, and a fourth adhesive and a fifth adhesive for creating side enclosures for the temperature control pocket.

### FIELD OF THE DISCLOSURE

The present application generally relates to a flexible container for temperature control.

### BACKGROUND

Temperature control of perishable items is important for preservation, but existing designs are bulky and impractical. For example, not all perishable items fit inside of a rigid wall container. Also, rigid wall containers can be difficult to move to the location where the item is located. Similarly, rigid wall containers cannot target temperature regulation to a particular location of the item, but rather require temperature regulation of the entire environment inside the container.

### SUMMARY

This Summary is provided to introduce a selection of concepts in a simplified form that are further described below in the Detailed Description. This Summary is not intended to identify key features or essential features, nor is it intended to limit the scope of the claims included herewith.

This disclosure describes a method and system for controlling the temperature of an item such as, but not limited to, meat and food. An aspect of this disclosure provides for an apparatus for controlling the temperature of a variety of items. The apparatus includes a sheet with fasteners and a temperature control device. The fasteners define a variety of pockets. The pockets define the sheet's structure and enclose the item. For example, the fasteners may allow the formation of a first pocket enclosing and item and also the formation of a second, container pocket which encloses the first pocket. The temperature control device may be enclosed by the first pocket. The fasteners may allow the temperature control device to be affixed to the sheet. Thus, for example, to keep an item cool, the sheet can be wrapped around the item. The fasteners secure the item inside the first pocket with the temperature control device. The fasteners then defines the formation of the second, container pocket to seals an item.

In one aspect, an apparatus for controlling the temperature of an item is disclosed. The system for controlling the temperature of an item includes a sheet with a front side and an obverse side. A first adhesive is disposed along a first edge of the sheet on the front side of the sheet, such that when the sheet folds over the item, the first adhesive engages with the sheet to create a container pocket having a container volume. A second adhesive is disposed on the front side of the sheet such that when the sheet folds over the item, the second adhesive engages with the front side of the sheet to create a temperature control pocket with a volume less than the container volume.

In some implementations, the first adhesive engages with the front side of the sheet. In certain implementations, the first adhesive engages with the obverse side of the sheet. In some implementations, a third adhesive is disposed on the sheet and capable of engaging to a modular pack. In certain implementations, the modular pack is engaged with the third adhesive.

In some implementations, a fourth adhesive and a fifth adhesive are disposed on the front side of the sheet and each perpendicular to the second adhesive. In certain implementations, a first side enclosure to the temperature control pocket is formed by the third adhesive engaged to the sheet. In certain implementations, a second side enclosure to the temperature control pocket is formed by the fourth adhesive engaged to the sheet.

In another aspect, a method for controlling the temperature of an item is described. A sheet with a front side and an obverse side is provided. A first adhesive is disposed along a first edge of the sheet on the front side of the sheet, and a second adhesive is disposed on the front side of the sheet. The sheet folds around the item. The first adhesive engages with the front side of the sheet to create a container pocket having a container volume. The second adhesive engages with the front side of the sheet to create a temperature controlled pocket having volume less than the container volume.

In some implementations, the provided apparatus includes a sheet with a front side and an obverse side. A first adhesive is disposed along a first edge of the sheet on the front side of the sheet. A second adhesive is disposed on the front side of the sheet. A third adhesive is disposed on the sheet. In certain implementations, a modular pack engages to the third adhesive.

In certain implementations, the provided apparatus includes a sheet with a front side and an obverse side. A first adhesive is disposed along a first edge of the sheet on the front side of the sheet. A second adhesive is disposed on the front side of the sheet. A third adhesive is disposed on the sheet. A fourth adhesive and a fifth adhesive are disposed on the front side of the sheet and each perpendicular to the second adhesive. In certain implementations, the fourth adhesive is engaged to the sheet to form a first side enclosure. In certain implementations, the fifth adhesive is engaged to the sheet to form a second side enclosure.

In another aspect, a method for controlling the temperature of an item is described. A sheet with a front side and an obverse side is provided. A first adhesive is disposed along a first edge of the sheet on the front side of the sheet, and a second adhesive is disposed on the front side of the sheet. The sheet folds around the item. The second adhesive engages with the obverse side of the sheet to create a temperature controlled pocket having a volume. The second adhesive engages with the front side of the sheet to create a container pocket having a container volume greater than the volume.

In some implementations, the provided apparatus includes a sheet with a front side and an obverse side. A first adhesive is disposed along a first edge of the sheet on the front side of the sheet. A second adhesive is disposed on the front side of the sheet. A third adhesive is disposed on the sheet. In certain implementations, a modular pack engages to the third adhesive.

In certain implementations, the provided apparatus includes a sheet with a front side and an obverse side. A first adhesive is disposed along a first edge of the sheet on the front side of the sheet. A second adhesive is disposed on the front side of the sheet. A third adhesive is disposed on the sheet. A fourth adhesive and a fifth adhesive are disposed on the front side of the sheet and each perpendicular to the second adhesive. In certain implementations, the fourth adhesive is engaged to the sheet to form a first side enclosure. In certain implementations, the fifth adhesive is engaged to the sheet to form a second side enclosure.

### BRIEF DESCRIPTION OF THE DRAWINGS

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a diagram depicting the front side of the sheet;

FIG. 1B is a diagram depicting an alternate implementation of the front side of the sheet;

FIG. 1C is a diagram depicting an alternate implementation of the front side of the sheet;

FIG. 2A is a cross-sectional side view showing the sheet folding over an item to create a temperature control pocket and a container pocket;

FIG. 2B is a diagram depicting the sheet forming a temperature controlled bag comprising the temperature control pocket and the container pocket;

FIG. 2C is a diagram depicting an alternate embodiment of the sheet forming a temperature controlled bag comprising the temperature control pocket and the container pocket;

FIG. 3A is a diagram depicting an alternate implementation of the temperature controlled pocket formed by the sheet;

FIG. 3B is a diagram depicting an alternate implementation of the sheet forming a container pocket;

FIG. 3C is a diagram depicting an alternate implementation of the sheet forming the temperature controlled bag comprising the temperature controlled pocket and the container pocket;

FIG. 4A is a graph depicting temperature control performance of the temperature controlled bag using 22.5% propylene glycol as the temperature control substance;

FIG. 4B is a graph depicting temperature control performance of the temperature controlled bag using 15.6% propylene glycol as the temperature control substance;

FIG. 4C is a graph depicting temperature control performance of the temperature controlled bag using 25% propylene glycol as the temperature control substance;

FIG. 4D is a graph depicting temperature control performance of the temperature controlled bag using water;

FIG. 4E is a graph depicting temperature control performance of two different temperature control bags;

FIG. 5A is a diagram depicting an permanent temperature control bag;

FIG. 5B is a diagram depicting an alternate embodiment of the permanent temperature control bag;

FIG. 5C is a diagram depicting the permanent temperature control bag closing over the item;

FIG. 5D is a diagram depicting the permanent temperature control bag closed over the item; and

FIG. 5E is a diagram depicting an implementation of the permanent temperature control bag with handles.

FIG. 5F is a diagram depicting temperature control performance of the temperature controlled bag with handles.

### DETAILED DESCRIPTION

For purposes of reading the description of the various embodiments below, the following descriptions of the sections of the specification and their respective contents may be helpful:

Items have desired temperatures for preservation. Controlling the temperature of items is one way to keep items preserved and at their appropriate temperature. The temperature control apparatus presented herein wraps around an item to target heating or cooling to the item. The present disclosure describes systems for a bag system and methods for using the bag. The temperature control bag forms adjustable temperature control containers or chambers and is a portable solution for temperature control of whole animals for many applications such as hunting, catering, rotisserie, camping, or tailgating.

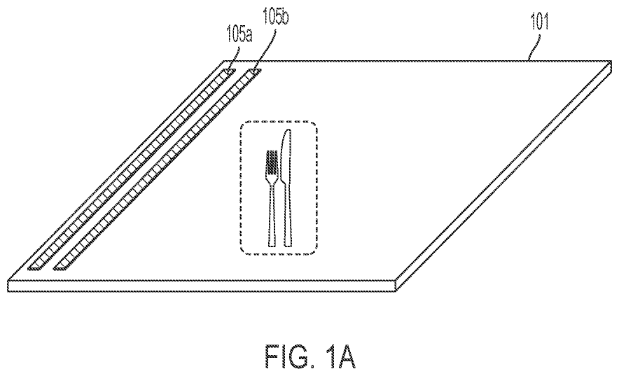

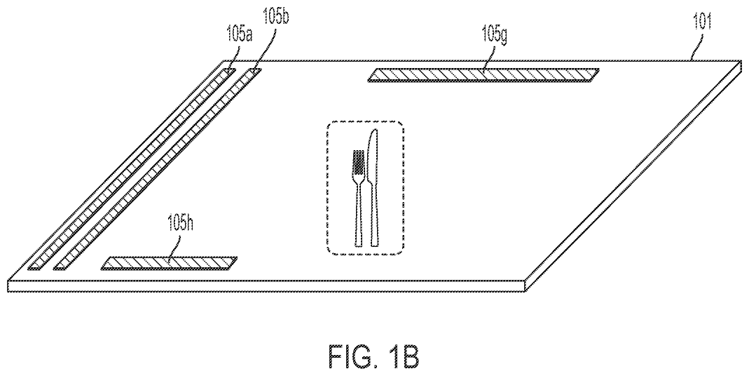

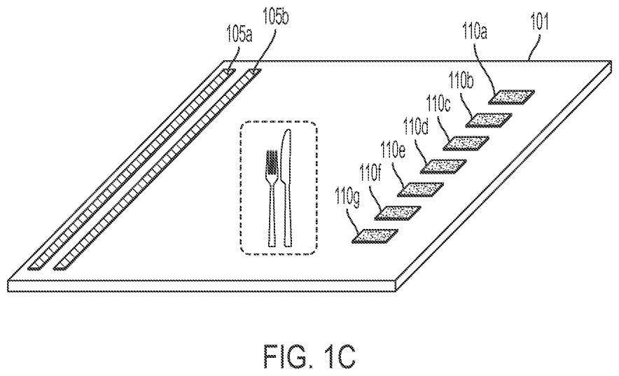

Referring now to FIG. 1A, and in brief overview, depicted is a front side of a sheet 101. The sheet 101 includes pocket-fasteners 105a, 105b (generally referred to as a fastener 105) to allow for various chambers to be formed when the sheet is folded. In some implementations, there is a three inch gap between the pocket-fastener 105a and pocket-fastener 105b. In some implementation, the pocket-fasteners 105 are peeled off. In some implementations, a minimum of two seals are required. In some implementations, the pocket-fastener 105 is known as a seal that provides a food grade double layered adhesive airtight seal. The pocket-fasteners 105 may be of different length or have a different position on the sheet 101 than as shown in FIG. 1A. The pocket-fastener 105 may be disposed on any side of the sheet 101 or may be disposed on multiple sides of the sheet 101. In some implementations, the pocket-fastener 105a is disposed to overlap with the pocket-fastener 105b. In some implementations, pocket-fastener 105a is disposed parallel to pocket-fastener 105b. In some implementations, pocket-fastener 105a is disposed adjacent to pocket-fastener 105b. In some implementations, pocket-fastener 105a is disposed along the edge of the sheet 101, from one corner to another corner. In some implementations, pocket-fastener 105b is disposed from one side of the sheet 101 to another side of the sheet 101. In some implementations, the surface area of pocket-fastener 105a is equal to the surface area of pocket-fastener 105b. In some implementations, the surface area of pocket-fastener 105a is greater than the surface area of pocket-fastener 105b. In some implementations, the surface area of pocket-fastener 105a is less than the surface area of pocket-fastener 105b. In some implementations, the surface area of pocket-fastener 105a is double the surface area of pocket-fastener 105b. In some implementations, the surface area of pocket-fastener 105a is triple the surface area of pocket-fastener 105b. Although shown in FIG. 1A as continuous strips, pocket-fasteners 105 may have any shape, including individual discrete elements, such as VELCRO dots. The pocket-fasteners 105 may include adhesive, tape, glue, a zipper, snaps, laces, or a hook-and-loop fastener and, in the embodiment shown in FIG. 1A, engage with the sheet 101 when the sheet 101 is folded. In some implementations, the layers of the tape of the pocket-fasteners 105 are peeled off as the sheet 101 begins to fold over.

Although shown in FIG. 1A disposed on the edge of sheet 101, pocket-fasteners 105 may be provided anywhere on the sheet, suitable for the creation of targeted temperature control chambers, as will be further described below.

Still referring to FIG. 1A, the sheet 101, in some embodiments, includes insulating foam or other fill material. In other embodiments, the sheet 101 includes air pockets. An item, such as a piece of meat or other item for which it is desired to control the temperature, is placed on the sheet 101. In some implementations, the item is placed in the center of the sheet 101. In some implementations, the item is placed on an edge of the sheet 101. In some implementations, the item is placed on the sheet 101 adjacent to a pocket-fastener 105. In some implementations, the item is on a side of the sheet 101 opposite the side of the pocket-fastener 105.

Referring now to FIG. 1B, an alternate embodiment of the sheet 101 is shown in which the sheet 101 includes pocket-fastener 105a, pocket-fastener 105b, pocket-fastener 105g, and pocket-fastener 105h. As shown in FIG. 1B, pocket-fasteners 105g, 105h are disposed along a different edge of the sheet 101 from that of pocket-fasteners 105a, 105b. In some implementations, pocket-fastener 105g or pocket-fastener 105h is disposed on the sheet 101 perpendicular to pocket-fastener 105a. In some implementations, pocket-fastener 105g or pocket-fastener 105h is disposed on the sheet 101 perpendicular to pocket-fastener 105b. In some implementations, the pocket-fastener 105g is disposed on the sheet 101 to overlap with the pocket-fastener 105h. In some implementations, the pocket-fastener 105g is disposed on the sheet 101 to overlap with the pocket-fastener 105a or pocket-fastener 105b. In some implementations, the pocket-fastener 105h is disposed on the sheet to overlap with the pocket-fastener 105a or pocket-fastener 105b. In some implementations, pocket-fastener 105g is disposed on the sheet parallel to pocket-fastener 105h. In some implementations, pocket-fastener 105g is disposed on the edge of the sheet 101. In some implementations, pocket-fastener 105h is disposed on the edge of the sheet 101 opposite pocket-fastener 105g. In some implementations, pocket-fastener 105g is disposed along the edge of the sheet 101 starting at pocket-fastener 105b and extending to a side of the sheet 101. In some implementations, pocket-fastener 105g is disposed along the edge of the sheet 101 starting at pocket-fastener 105a and extending to a side of the sheet 101. In some implementations, pocket-fastener 105g is disposed on the sheet 101 starting at pocket-fastener 105b and extending to a side of the sheet 101. In some implementations, the surface area of pocket-fastener 105g is equal to the surface area of pocket-fastener 105h. In some implementations, the surface area of pocket-fastener 105g is greater than the surface area of pocket-fastener 105h. In some implementations, the surface area of pocket-fastener 105g is less than the surface area of pocket-fastener 105h. In some implementations, the surface area of pocket-fastener 105g is double the surface area of pocket-fastener 105h. In some implementations, the surface area of pocket-fastener 105g is triple the surface area of pocket-fastener 105h. In some implementations, pocket-fastener 105g is disposed adjacent to pocket-fastener 105a. In some implementations, pocket-fastener 105g is disposed adjacent to pocket-fastener 105b. In some implementations, pocket-fastener 105h is disposed adjacent to pocket-fastener 105a. In some implementations, pocket-fastener 105h is disposed adjacent to pocket-fastener 105b.

Referring now to FIG. 1D, an alternate embodiment of the sheet 101 is shown which allows for a temperature control pack to be affixed to the sheet 101 prior to folding. In some embodiments, sheet 101 directs temperature control by receiving or coupling to a temperature control device, such as an ice pack, a heating pack, or the modular temperature control pack disclosed by U.S. Ser. No. ______, filed of even date herewith and bearing Attorney's Docket Number BBQ-003 (122566-0104), the contents of which are incorporated herein by reference. The sheet 101 shown in FIG. 1D includes pack-fasteners 110a-110g (generally referred to as a pack-fastener 110). The pack-fastener 110 is disposed on the sheet 101. The temperature control pack (not shown) attaches to the one or more of the pack-fasteners 110 by providing a complementary portion of the pack-fasteners 110 provided on the sheet 101. The placement of the ice pack, the heating pack, or the modular temperature control pack with the pocket-fastener 105 or the pack-fastener 110 allows the user to place the modular temperature control pack close to the proximity of the item. In some implementations, the pack-fastener 110 is disposed on any edge of the sheet, or disposed on multiple edges. In some implementations, the surface area of each pack-fastener 110 is equal to the surface area of another pack-fastener 110. In some implementations, the surface area of the pack-fastener 110 is equal the surface area of the pocket-fastener 105. In some implementations, the item engages to the pack-fastener 110.

In some implementations, the pack-fastener 110a, the pack-fastener 110b, or the pack-fastener 110c is disposed between pocket-fastener 105a and pocket-fastener 105b. In some implementations, the pack-fastener 110a, the pack-fastener 110b, or the pack-fastener 110c is disposed perpendicular to pocket-fastener 105a. In some implementations, the pack-fastener 110a, the pack-fastener 110b, or the pack-fastener 110c is disposed perpendicular to pocket-fastener 105b.

In some implementations, the pack-fastener 110a, the pack-fastener 110b, or the pack-fastener 110c is disposed to overlap with the pack-fastener 110a, the pack-fastener 110b, or the pack-fastener 110c. In some implementations, the pack-fastener 110a, the pack-fastener 110b, or the pack-fastener 110c is disposed parallel to the pack-fastener 110a, the pack-fastener 110b, or the pack-fastener 110c. In some implementations, the pack-fastener 110a, the pack-fastener 110b, or the pack-fastener 110c is disposed on the edge of the sheet 101. In some implementations, the pack-fastener 110a, the pack-fastener 110b, or the pack-fastener 110c is disposed on the edge of the sheet 101 opposite pocket-fastener 105a. In some implementations, the pack-fastener 110a, the pack-fastener 110b, or the pack-fastener 110c is disposed on the edge of the sheet 101 opposite pocket-fastener 105b.

In some implementations, the pack-fastener 110a, the pack-fastener 110b, or the pack-fastener 110c is disposed along the edge of the sheet 101 from pocket-fastener 105b to an edge of the sheet 101. In some implementations, the pack-fastener 110a, the pack-fastener 110b, or the pack-fastener 110c is disposed along the edge of the sheet 101 from pocket-fastener 105a to an edge of the sheet 101. In some implementations, the pack-fastener 110a, the pack-fastener 110b, or the pack-fastener 110c is disposed on the sheet 101 from pocket-fastener 105b to an edge of the sheet 101. In some implementations, the pack-fastener 110a, the pack-fastener 110b, or the pack-fastener 110c is disposed on the sheet 101 from pocket-fastener 105a to a side of the sheet. In some implementations, the pack-fastener 110a, the pack-fastener 110b, or the pack-fastener 110c is disposed adjacent to the item on the sheet 101. In some implementations, the pack-fastener 110a, the pack-fastener 110b, or the pack-fastener 110c is disposed adjacent to pocket-fastener 105a. In some implementations, the pack-fastener 110a, the pack-fastener 110b, or the pack-fastener 110c is disposed adjacent to pocket-fastener 105b. In some implementations, the pack-fastener 110a, the pack-fastener 110b, or the pack-fastener 110c is disposed adjacent to pocket-fastener 105a. In some implementations, the pack-fastener 110a, the pack-fastener 110b, or the pack-fastener 110c is disposed adjacent to pocket-fastener 105b. In some implementations, the pack-fastener 110a, the pack-fastener 110b, or the pack-fastener 110c couple to temperature control device (not shown). The temperature control device includes the complementary portion of pack-fastener 110 to engage with the pack-fasteners 110. In some implementations, the temperature control device engages with a single pack-fastener 110a-110g. In still other embodiments, the temperature control device engages with multiple ones of the pack-fasteners 110a-110g. For example, the temperature control device may engage with pack-fasteners 110f, 110g.

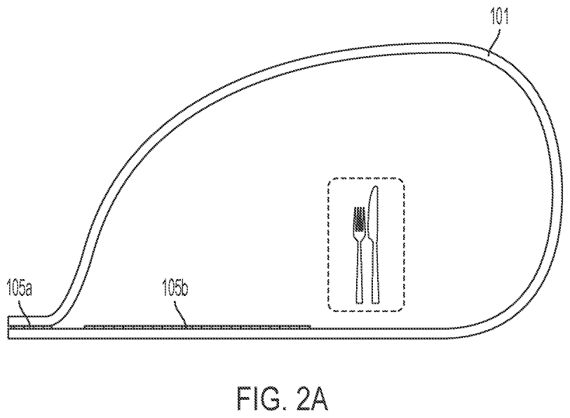

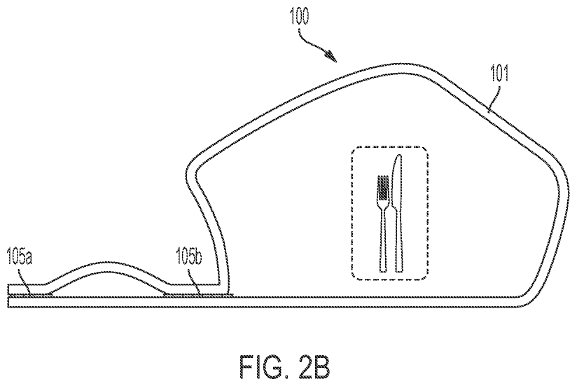

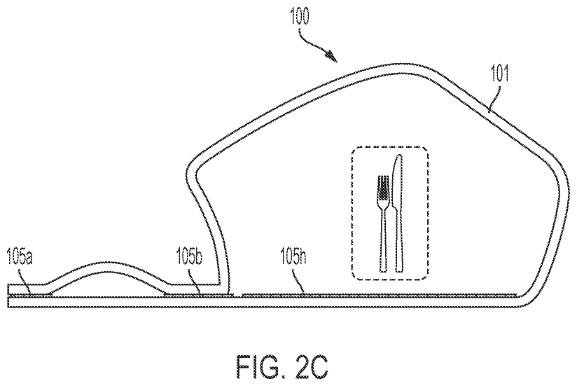

Referring now to FIG. 2A, a cross-sectional side view the sheet 101 enclosing an item is shown. As shown in FIG. 2A, in brief overview, the sheet 101 folds over an item, the edge of the sheet engages with the pocket fastener 105a, and a container pocket forms. In some implementations, the sheet 101 touches the item while folding to reduce the temperature control area or volume inside the temperature controlled pocket. The edge of sheet 101 engages with pocket-fastener 105a to seal the sheet 101 around the item and create a container pocket. In some implementations, the temperature controlled pocket or the container pocket are airtight. The zone encompassed by the container pocket is the container volume. The pocket-fastener 105b engages with the sheet 101 to form a temperature controlled pocket encompassing the item. The zone encompassed by the temperature controlled pocket is the temperature controlled volume. The container pocket encompasses the temperature controlled pocket. The container volume is greater than the temperature controlled volume. In some implementations, the temperature controlled pocket molds to the shape of the item. In some implementations, the temperature controlled pocket temperature is less than the container pocket temperature. In some implementations, the temperature controlled pocket includes the ice pack, the heating pack, or the modular temperature control pack. In some implementations, the container pocket includes the ice pack, the heating pack, or the modular temperature control pack.

Referring to FIG. 2B, depicted is a cross-sectional side view of an implementation of the sheet 101 enclosing an item. As shown in FIG. 2B, in brief overview, pocket-fastener 105b engages with the sheet 101 to create a first, temperature controlled pocket. The container pocket encompasses the temperature control pocket. The temperature controlled pocket and the container pocket form a temperature control bag 100. In some implementations, the sheet 101 creates a temperature control bag 100 by forming the container pocket and the temperature controlled pocket. In some implementations, the temperature control bag 100 creates a targeted temperature control zone in an area adjacent to a temperature control device. In some implementations, the temperature control bag 100 includes adjustable sizing of the bag for large and small animals. In some implementations, the temperature control bag 100 is combined with an ice bath to control the temperature in the temperature controlled pocket or the container pocket. In some implementations, the temperature control bag 100 includes a double seal to maintain or control the temperature in the container pocket or the temperature controlled pocket. In some implementations, the temperature control bag 100 includes multiple seals that allow user to size the bag to the animal. Although the temperature control bag 100 maintains an ambient temperature of the chamber, in some implementations, the temperature control bag directs the temperature control to the surface of the item. In some implementations, the temperature control bag 100 applies temperature control to where it is most desired.

Referring to FIG. 2C, depicted is a cross-sectional side view of an alternate implementation of the sheet 101 enclosing an item. As shown in FIG. 2C, in brief overview, pocket-fastener 105h engages with the sheet 101 to create a side enclosure for the temperature controlled pocket. The temperature control bag 100 comprising a temperature controlled pocket and a container pocket. The sheet 101 includes the pocket-fastener 105h. The pocket-fastener 105h engages with the sheet 101 to form a side enclosure for the temperature controlled pocket. In some implementations, the pocket-fastener 105h engages with the temperature controlled pocket and the container pocket.

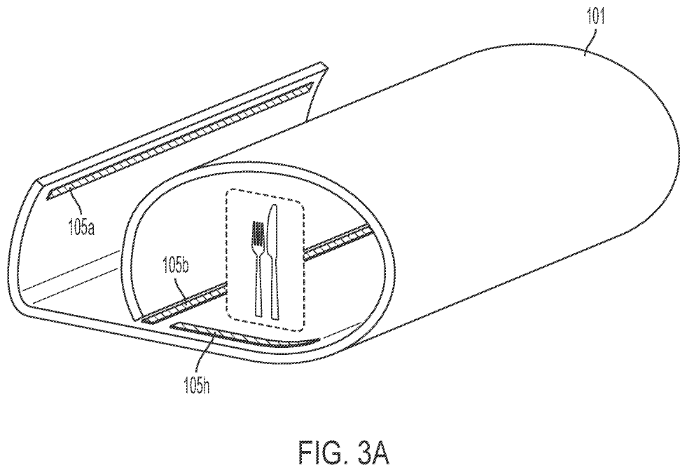

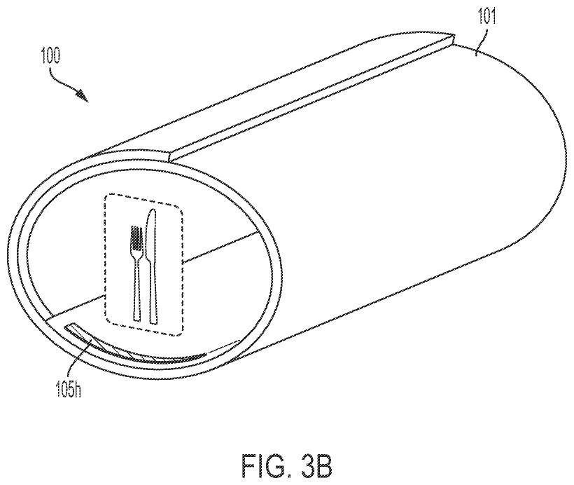

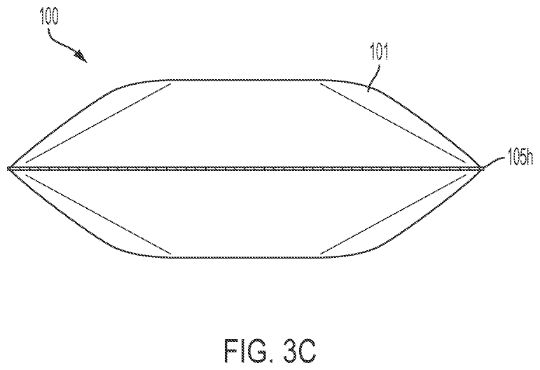

Referring to FIG. 3A, depicted is a cross-sectional side view of the sheet 101. As shown in FIG. 3A, in brief overview, the sheet 101 wraps around the item, the edge of the obverse side of the sheet 101 engages with the pocket fastener 105b on the front side of the sheet 101, and a temperature controlled pocket encompassing the item forms. The pocket-fastener 105a on the front side of the sheet engages with the obverse side of the sheet 101 to form a container pocket. The pocket-fastener 105h is capable of connecting or engaging with the sheet 101 to form a side enclosure for the temperature controlled pocket. In some implementations, the temperature controlled pocket or the container pocket are airtight. In some implementations, the temperature controlled pocket molds to the shape of the item. In some implementations, the temperature controlled pocket includes the ice pack, the heating pack, or the modular temperature control pack.

Referring to FIG. 3B, depicted is a side view of the temperature control bag 100. The sheet 101 wraps around the item. As shown in FIG. 3A, in brief overview, the temperature controlled pocket and the container pocket form a temperature control bag 100. The temperature control bag 100 includes a temperature control pocket and a container pocket. The pocket-fastener 105h engages with the sheet 101 to form a side enclosure for the temperature controlled pocket. The zone encompassed by the container pocket is the container volume. The zone encompassed by the temperature controlled pocket is the temperature controlled volume. The container pocket encompasses the temperature controlled pocket. The container volume is greater than the temperature controlled volume. In some implementations, the temperature controlled pocket temperature is less than the container pocket temperature. In some implementations, the container pocket includes the ice pack, the heating pack, or the modular temperature control pack.

Referring to FIG. 3C, depicted is a cross-sectional side view of the temperature control bag 100. As shown in FIG. 3A, in brief overview, pocket-fastener 105h engages with the sheet 101 to form a side enclosure for the temperature control bag 100. The temperature control bag 100 may include the ice pack, the heating pack, or the modular temperature control pack. The zone encompassed by the temperature control bag is the temperature control bag volume. The temperature control bag volume may be equal to the container volume. The temperature control bag volume may be greater than the temperature controlled volume. In some implementations, the temperature control bag 100 is observed to cool and maintains the temperature of an animal or meat for 24 hours.

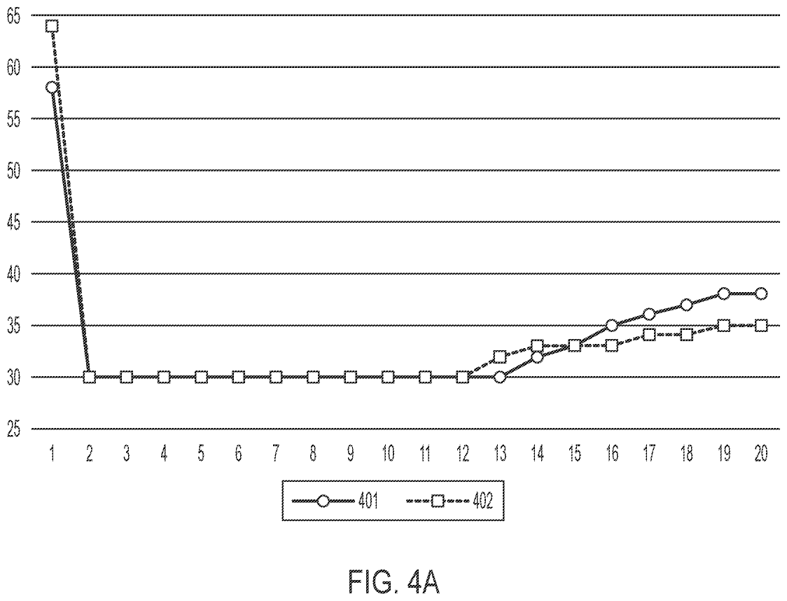

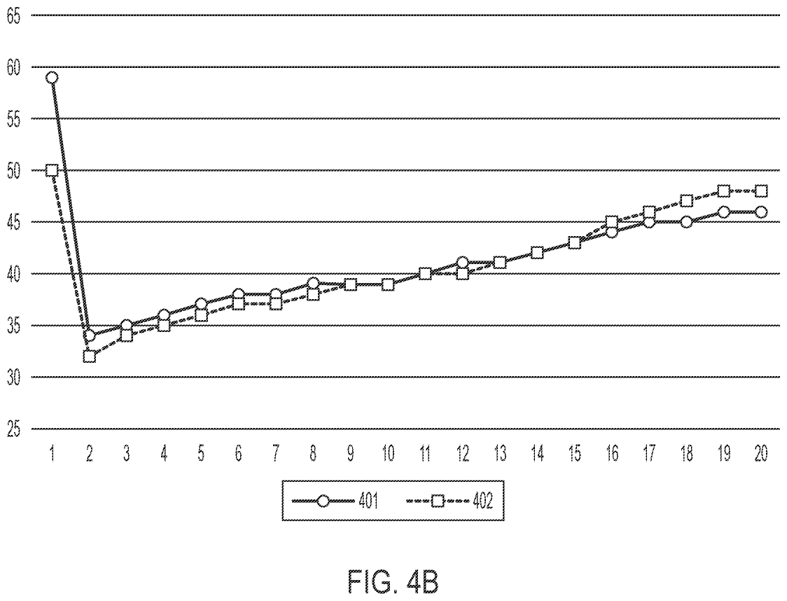

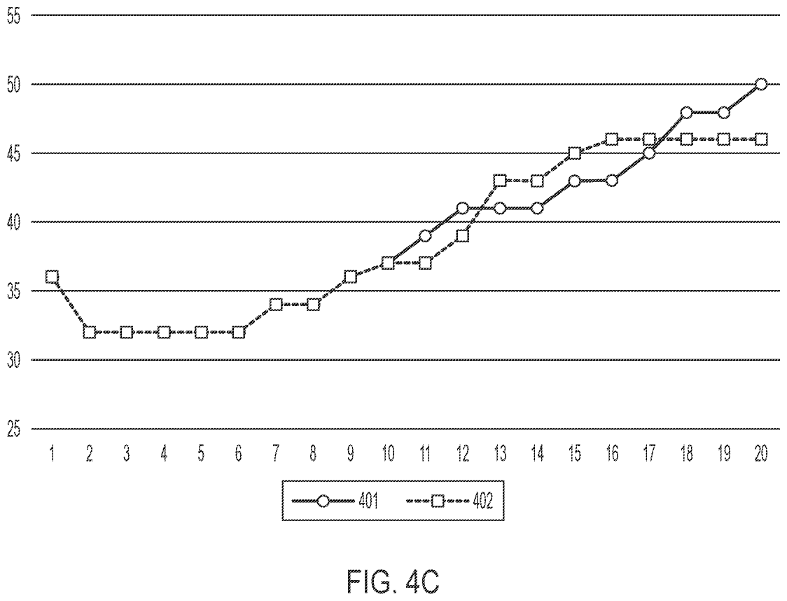

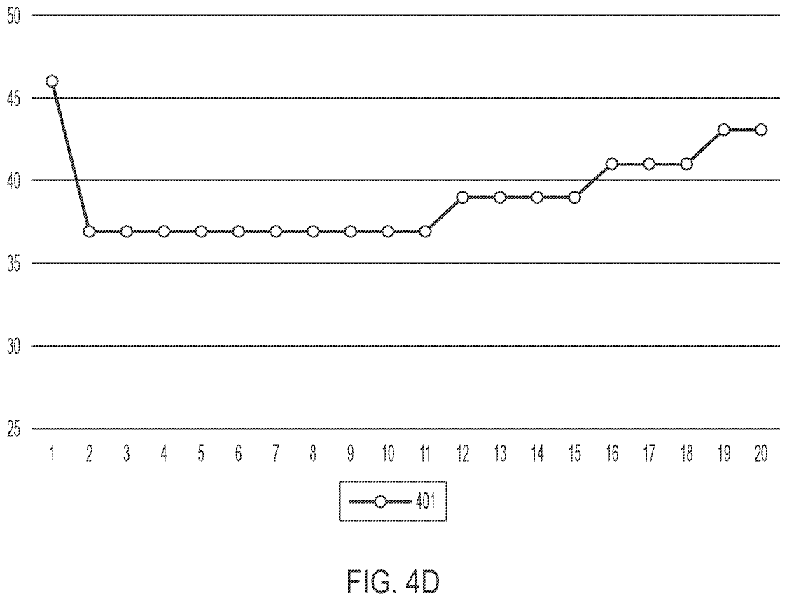

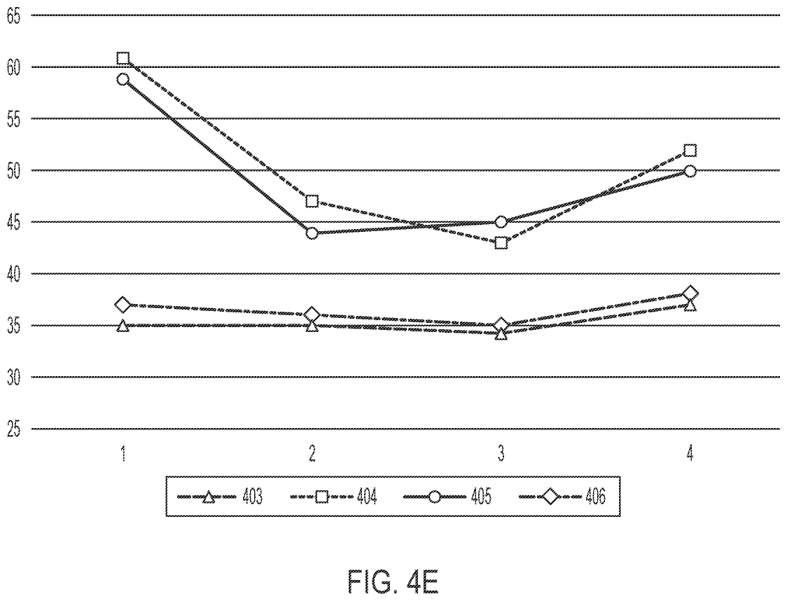

The present technology is further illustrated in FIGS. 4A-4E, which should not be construed as limiting in any way. The FIGS. 4A-4E demonstrates the preparation, characterization, and use of the temperature control bag 100.

Referring to FIG. 4A, depicted is a graph of experimental data corresponding to temperature control performance of the temperature control bag 100 with 22.5% propylene glycol and 77.5% water. The test conditions included ambient temperatures ranging from 75-78 degrees Fahrenheit and 40 pounds of hamburger as the item in the temperature control bag 100. The test lasted 20 hours and the temperature control bag 100 included a 20-pouch modular temperature control pack for temperature control. The temperature control substance comprises 22.5% propylene glycol and 77.5% water. Temperature probe 401 is placed at the front end of the temperature control bag 100, and temperature probe 402 is placed at the back end of the temperature control bag 100. In some implementations, placing the probes at the extreme ends of the temperature control bag 100 acquires the worst case temperature result. The temperature probes were placed in what is herein described as the temperature controlled pocket.

As shown in FIG. 4A, the x-axis is time in hours and the y-axis is temperature in Fahrenheit. The total temperature rise is observed to be 8 degrees from the front of the temperature control bag 100. The total temperature rise is observed to be 5 degrees from the back of the temperature control bag 100. There is no temperature rise observed for 12 hours. The meat is observed to stay under 40 degrees for 20 hours.

Referring to FIG. 4B, depicted is a graph of experimental data corresponding to temperature control performance of the temperature control bag 100 with 15.6% propylene glycol and 84.4% water. The test conditions included ambient temperatures ranging from 75-78 degrees Fahrenheit and 40 pounds of hamburger as the item in the temperature control bag 100. The test lasted 20 hours and the temperature control bag 100 included a 20-pouch modular temperature control pack for temperature control. The temperature control substance comprises 15.6% propylene glycol and 84.4% water. Temperature probe 401 is placed at one front end of the temperature control bag 100, and temperature probe 402 is placed at the opposite back end of the temperature control bag 100. In some implementations, placing the probes at the extreme ends of the temperature control bag 100 acquires the worst case temperature result. The temperature probes were placed in what is herein described as the temperature controlled pocket.

As shown in FIG. 4B, the x-axis is time in hours and the y-axis is temperature in Fahrenheit. The total temperature rise is observed to be 12 degrees from the front of the temperature control bag 100. The total temperature rise is observed to be 16 degrees from the back of the temperature control bag 100. As observed, using this configuration demonstrated a quick temperature increase. Nonetheless, the meat was observed to stay under 50 degrees for 20 hours.

Referring to FIG. 4C, depicted is a graph of experimental data corresponding to temperature control performance of the temperature control bag 100 with 25% propylene glycol and 75% water. The test conditions included ambient temperatures ranging from 75-78 degrees Fahrenheit and 40 pounds of hamburger as the item in the temperature control bag 100. The test lasted 20 hours and the temperature control bag 100 included a 20-pouch modular temperature control pack for temperature control. The temperature control substance comprises 25% propylene glycol and 75% water. Temperature probe 401 is placed at one front end of the temperature control bag 100, and temperature probe 402 is placed at the opposite back end of the temperature control bag 100. In some implementations, placing the probes at the extreme ends of the temperature control bag 100 acquires the worst case temperature result. The temperature probes were placed in what is herein described as the temperature controlled pocket.

As shown in FIG. 4C, the x-axis is time in hours and the y-axis is temperature in Fahrenheit. The total temperature rise is observed to be 18 degrees from the front of the temperature control bag 100. The total temperature rise is observed to be 14 degrees from the back of the temperature control bag 100. The meat temperature is observed to stay under 50 degrees for 20 hours.

Referring to FIG. 4D, depicted is a graph of experimental data corresponding to temperature control performance of the temperature control bag 100 with water. The test conditions included ambient temperatures ranging from 75-78 degrees Fahrenheit and 40 pounds of hamburger as the item in the temperature control bag 100. The test lasted 20 hours and the temperature control bag 100 included a 20-pouch modular temperature control pack for temperature control. The temperature control substance comprises water. Temperature probe 401 is placed at one front end of the temperature control bag 100. The temperature probes were placed in what is herein described as the temperature controlled pocket.

As shown in FIG. 4D, the x-axis is time in hours and the y-axis is temperature in Fahrenheit. The total temperature rise is observed to be 6 degrees from the front of the temperature control bag 100. The meat temperature is observed to stay under 50 degrees for 20 hours.

Referring to FIG. 4E, depicted is a comparison graph of experimental data corresponding to the temperature control bag 100 with the best performance and the temperature control bag 100 with the worst performance in the 22.5% propylene glycol test. The best performance is defined as the lowest temperatures of the meat and ambient, and the worst performance is defined as the highest temperatures of the meat and ambient. The best and worst temperature control bag 100 uses the same 20 pouch modular temperature control pack for temperature regulation.

As shown in FIG. 4E, the x-axis is time in hours and the y-axis is temperature in Fahrenheit. Meat A 403 and ambient A 404 are from the temperature control bag 100 with the best performance because it was observed to have the lowest temperatures, and ambient C 405 and meat C 406 are from the temperature control bag 100 with the worst performance because it was observed to have the highest temperatures. Despite the using two different temperature control bags 100, the meat A 403 temperature is observed to initially be close to the meat C 406 temperatures, and by the end of the test, the meat A 403 temperature is observed to be identical to the meat C 406 temperature. The ambient temperatures of the temperature control pocket exhibits similar performance. Ambient A 404 temperature is initially observed to be close to the ambient C 405 temperatures, and by the end of the test, the ambient A 404 temperature is observed to be greater than the meat C 406 temperature.

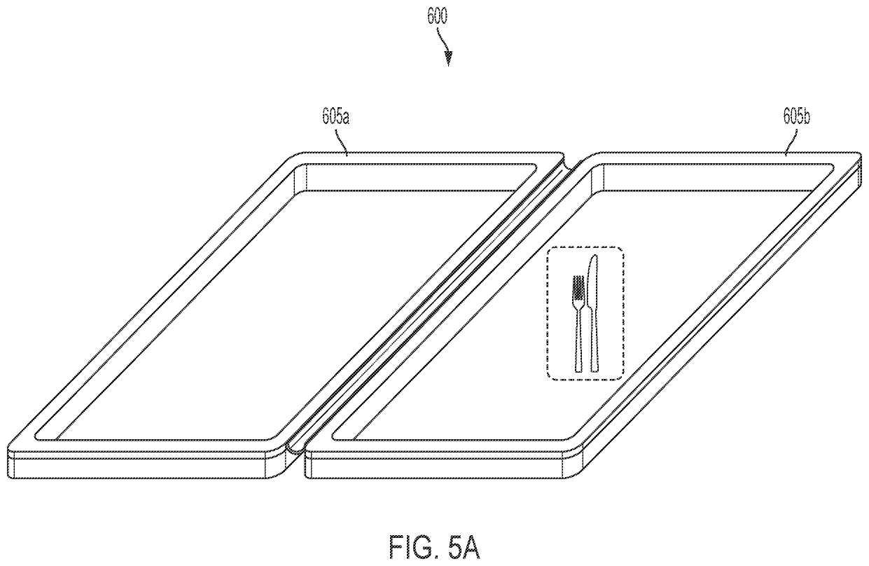

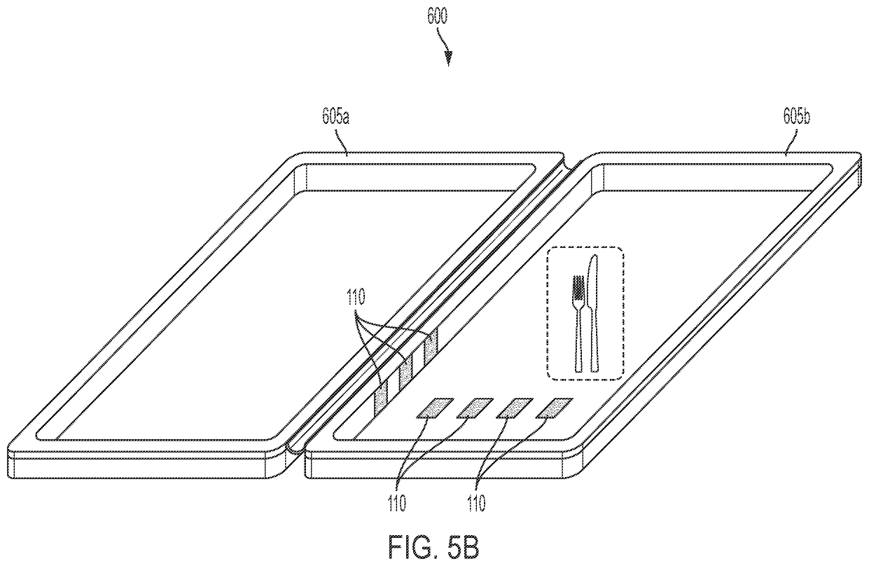

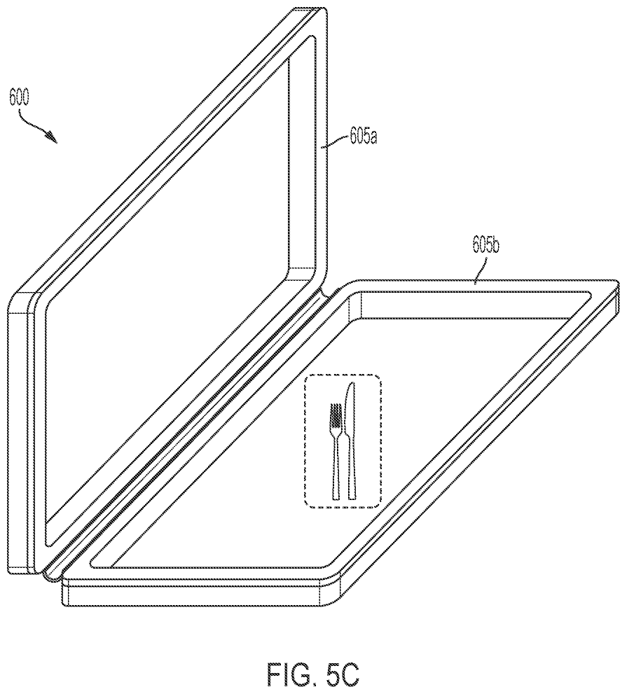

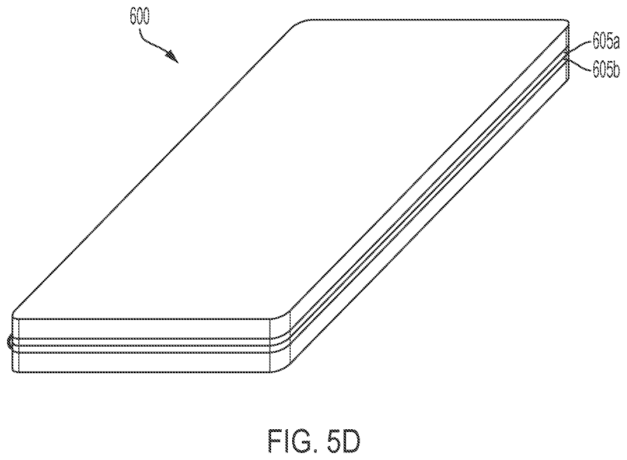

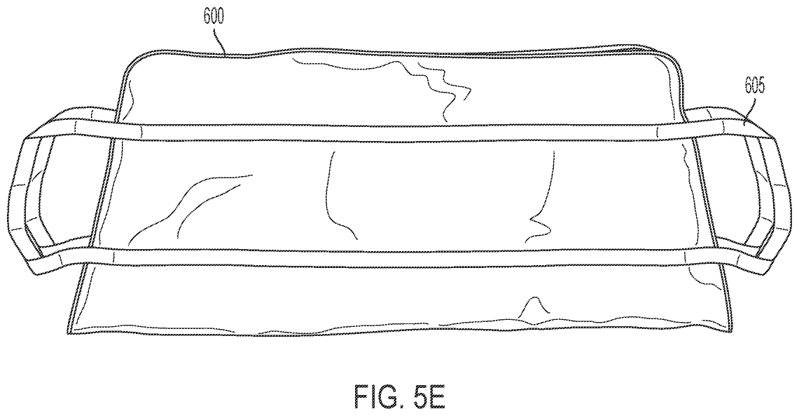

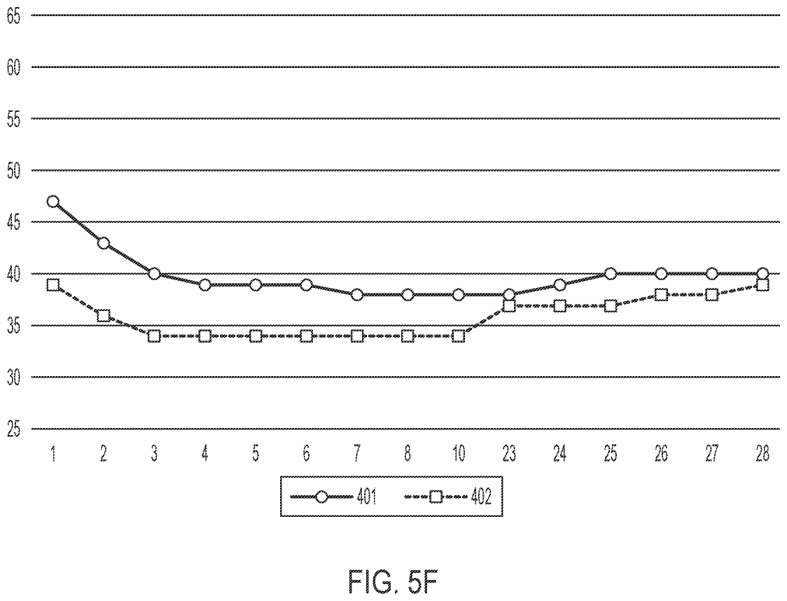

Referring to FIG. 5A, depicted is a permanent temperature control bag 600. The permanent temperature control bag 600 may be an implementation of the temperature controlled bag 100 capable of retaining its shape. In some implementations, the permanent temperature control bag 600 is a permanent implementation of the temperature control bag 100. The item is placed inside the permanent temperature control bag 600. The permanent temperature control bag 600 may include an impermeable seal 605a and an impermeable seal 605b. The permanent temperature control bag 600 may include a first half and a second half. The impermeable seal 605a is disposed to the first half and the impermeable seal 605b is disposed to the second half. In some implementations, the impermeable seal 605a or the impermeable seal 605b are disposed along the edges of the permanent temperature control bag 600.

Referring to FIG. 5B, depicted is an alternate embodiment of the permanent temperature control bag 600. The maintenance bag 600 may include the pack-fastener 110 disposed on the inside of the permanent temperature control bag 600. In some implementations, the pack-fastener 110 is disposed to the permanent temperature control bag 600. In some implementations, the permanent temperature control bag 600 includes the ice pack, the heating pack, or the modular temperature control pack. In some implementations, the ice pack, the heating pack, or the modular temperature control pack engages with the permanent temperature control bag 600 by connecting to the pack-fastener 110 disposed on the permanent temperature control bag 600. In some implementations, the item engages to the pack-fastener 110.

Referring to FIG. 5C, depicted is the permanent temperature control bag 600. The second half of the permanent temperature control bag 600 may fold over the first half of the permanent temperature control bag 600. In some implementations, the second half of the permanent temperature control bag 600 is upright over the item. In some implementations, the second half of the permanent temperature control bag 600 leans on the item.

Referring to FIG. 5D, depicted is the permanent temperature control bag 600. The impermeable seal 605a and the impermeable seal 605b are engaged. The first half of the permanent temperature control bag 600 and the second half of the permanent temperature control bag 600 are coupled together. The zone encompassed by the permanent temperature control bag 600 may be the temperature controlled pocket. In some embodiments, the modular temperature pack wraps around the outside of the permanent temperature control bag 600.

Referring to FIG. 5E, depicted is an implementation of the permanent temperature control bag 600 with a handle 605. The handle 605 is disposed on the permanent temperature control bag 600. A first portion of the handle 605 is attached to the permanent temperature control bag 600 a second portion of the handle 605 is not attached to the permanent temperature control bag 600. In some implementations, the handle 605 is attached to the permanent temperature control bag 600 in a first location and a second location. In some implementations, the first location is parallel to the second location. In some implementations, a first handle is disposed on a second handle. In some implementations, the handle 605 is cloth. In some implementations, the handle 605 is a piece of material.

The present technology is further illustrated in FIG. 5F, which should not be construed as limiting in any way. The FIG. 5F demonstrates the preparation, characterization, and use of the permanent temperature control bag 600.

Referring to FIG. 5F, depicted is a graph of experimental data corresponding to temperature control performance of the permanent temperature control bag 600. The test conditions included ambient temperatures ranging from 75-78 degrees Fahrenheit and 40 pounds of hamburger as the item in the permanent temperature control bag 600. The test lasted 28 hours and the temperature control bag 100 included a 20-pouch modular temperature control pack for temperature control. The temperature control substance comprises 22.5% propylene glycol and 77.5% water. Temperature probe 401 is placed at the front end of the permanent temperature control bag 600, and temperature probe 402 is placed at the opposite back end of the permanent temperature control bag 600. In some implementations, placing the probes at the extreme ends of the permanent temperature control bag 600 acquires the worst case temperature result. The temperature probes were placed in what is herein described as the temperature controlled pocket.

As shown in FIG. 5F, the x-axis is time in hours and the y-axis is temperature in Fahrenheit. The total temperature rise is observed to be 3 degrees from the front of the permanent temperature control bag 600. The total temperature rise is observed to be 3 degrees from the back of the permanent temperature control bag 600. There is no temperature rise observed for 10 hours. The meat is observed to stay under 40 degrees for 28 hours.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference.

We claim:

1. An apparatus for controlling the temperature of an item comprising:
a sheet with a front side and an obverse side;
a first adhesive disposed along a first edge of the sheet on the front side of the sheet, such that when the sheet is folded over the item, the first adhesive engages with the sheet to create a container pocket having a container volume; and
a second adhesive disposed on the front side of the sheet such that when the sheet is folded over the item, the second adhesive engages with the front side of the sheet to create a temperature control pocket with a temperature control volume less than the container volume.

2. The apparatus from claim 1, wherein the first adhesive engages with the front side of the sheet.

3. The apparatus from claim 1, wherein the first adhesive engages with the obverse side of the sheet.

4. The apparatus from claim 1, further comprising a third adhesive disposed on the sheet.

5. The apparatus from claim 4, further comprising a modular pack engaged to the third adhesive.

6. The apparatus from claim 1, further comprising a fourth adhesive and a fifth adhesive disposed on the front side of the sheet and each perpendicular to the second adhesive.

7. The apparatus from claim 6, further comprising a first side enclosure to the temperature control pocket formed by the third adhesive engaged to the sheet.

8. The apparatus from claim 7, further comprising a second side enclosure to the temperature control pocket formed by the fourth adhesive engaged to the sheet.

9. A method for controlling the temperature of an item comprising:
providing an apparatus comprising:
a sheet with a front side and an obverse side;
a first adhesive disposed along a first edge of the sheet on the front side of the sheet; and
a second adhesive disposed on the front side of the sheet;
folding the sheet around the item;
engaging the first adhesive with the front side of the sheet to create a container pocket having a container volume; and
engaging the second adhesive with the front side of the sheet to create a temperature controlled pocket having volume less than the container volume.

10. The method for controlling the temperature of the item of claim 9, wherein providing an apparatus comprises:
providing an apparatus comprising:
a sheet with a front side and an obverse side;
a first adhesive disposed along a first edge of the sheet on the front side of the sheet;
a second adhesive disposed on the front side of the sheet; and
a third adhesive disposed on the sheet.

11. The method for controlling the temperature of the item of claim 10, further comprising engaging a modular pack to the third adhesive.

12. The method for controlling the temperature of the item of claim 9, wherein providing an apparatus comprises:
providing an apparatus comprising:
a sheet with a front side and an obverse side;
a first adhesive disposed along a first edge of the sheet on the front side of the sheet;
a second adhesive disposed on the front side of the sheet;
a third adhesive disposed on the sheet; and
a fourth adhesive and a fifth adhesive disposed on the front side of the sheet and each perpendicular to the second adhesive;

13. The method for controlling the temperature of the item of claim 13, further comprising engaging the fourth adhesive to the sheet to form a first side enclosure.

14. The method for controlling the temperature of the item of claim 14, further comprising engaging the fifth adhesive to the sheet to form a second side enclosure.

15. A method for controlling the temperature of an item comprising:
providing an apparatus comprising:
a sheet with a front side and an obverse side;
a first adhesive disposed along a first edge of the sheet on the front side of the sheet; and
a second adhesive disposed on the front side of the sheet;
folding the sheet around the item;
engaging the second adhesive with the obverse side of the sheet to create a temperature controlled pocket having a volume; and
engaging the first adhesive with the obverse side of the sheet to create a container pocket having a container volume greater than the volume.

16. The method for controlling the temperature of the item of claim 15, wherein providing an apparatus comprises:
providing an apparatus comprising:
a sheet with a front side and an obverse side;
a first adhesive disposed along a first edge of the sheet on the front side of the sheet;
a second adhesive disposed on the front side of the sheet; and
a third adhesive disposed on the sheet.

17. The method for controlling the temperature of the item of claim 16, further comprising engaging a modular pack to the third adhesive.

18. The method for controlling the temperature of the item of claim 15, wherein providing an apparatus comprises:
providing an apparatus comprising:
a sheet with a front side and an obverse side;
a first adhesive disposed along a first edge of the sheet on the front side of the sheet;
a second adhesive disposed on the front side of the sheet;
a third adhesive disposed on the sheet; and
a fourth adhesive and a fifth adhesive disposed on the front side of the sheet and each perpendicular to the second adhesive;

19. The method for controlling the temperature of the item of claim 13, further comprising engaging the fourth adhesive to the sheet to form a first side enclosure.

20. The method for controlling the temperature of the item of claim 14, further comprising engaging the fifth adhesive to the sheet to form a second side enclosure.
